(19) United States
(12) Patent Application Publication
(10) Pub. No.: US 2026/0289346 A1
(43) Pub. Date: Sep. 24, 2026

(54) Systems and Methods for an Operator Separated Cognitive Architecture for AI Reasoning

(71) Applicant: Matthew Thornton, Houston, TX (US)

(72) Inventor: Matthew Thornton, Houston, TX (US)

(21) Appl. No.: 19/543,866

(22) Filed: Feb. 19, 2026

(51) Int. Cl. G06N 5/04

(52) U.S. Cl. CPC G06N 5/04

(57) ABSTRACT

A cognitive architecture is disclosed in which cognitive processing is performed through a plurality of structurally separated operators, including at least a limitation operator, a generation operator, a collapse operator, and a fixed-point operator. The architecture enforces operator boundaries and operator ordering such that limitation precedes plenitude, generation is constrained by predefined boundaries, collapse is executed as a controlled operator rather than an emergent behavior, and outputs converge toward a fixed-point anchor state. The disclosed system provides non-emergent coherence, improved stability, and reduced drift by treating cognitive functions as discrete operators within an operator grammar. Methods of implementing the architecture, executing operator transitions, and maintaining coherence across inference sequences are also described.

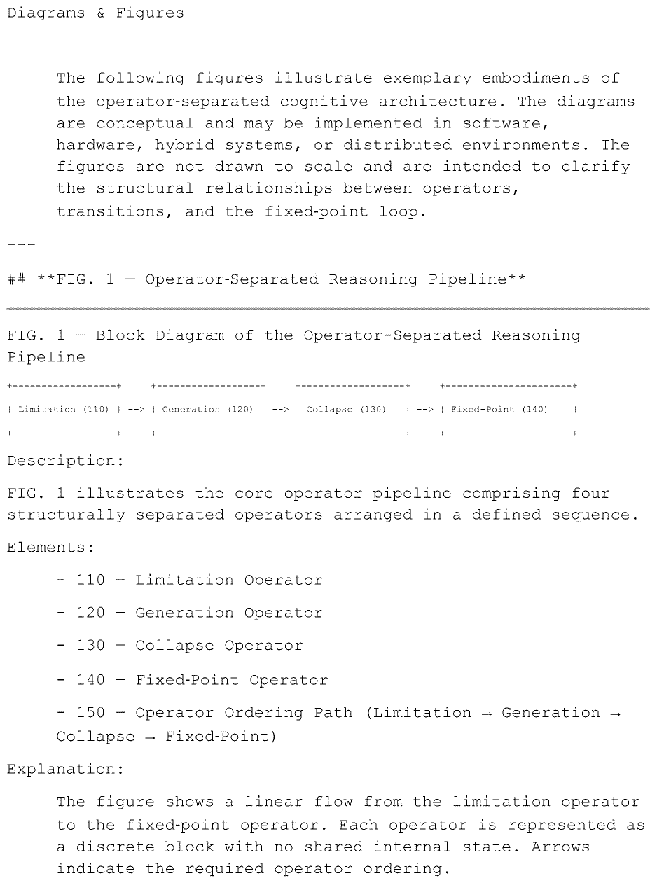

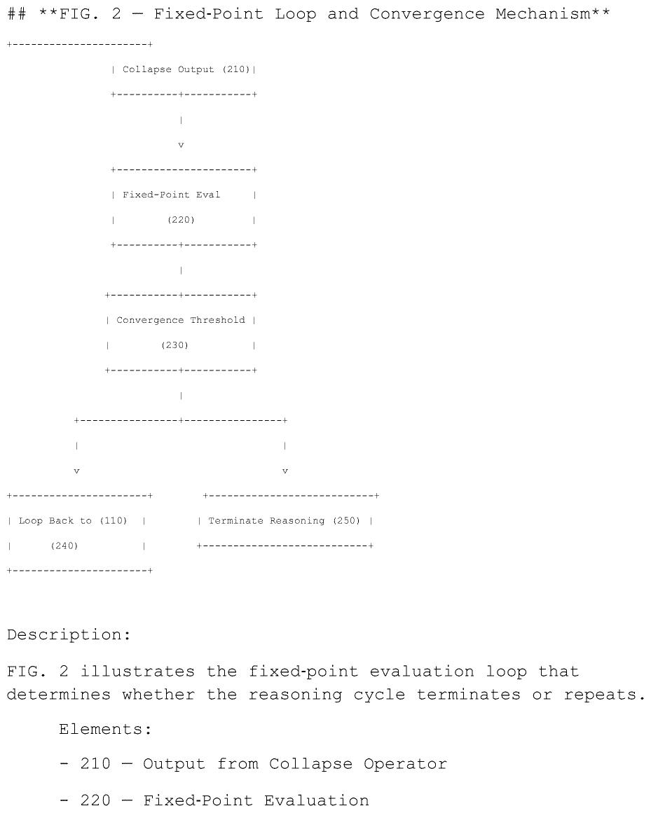

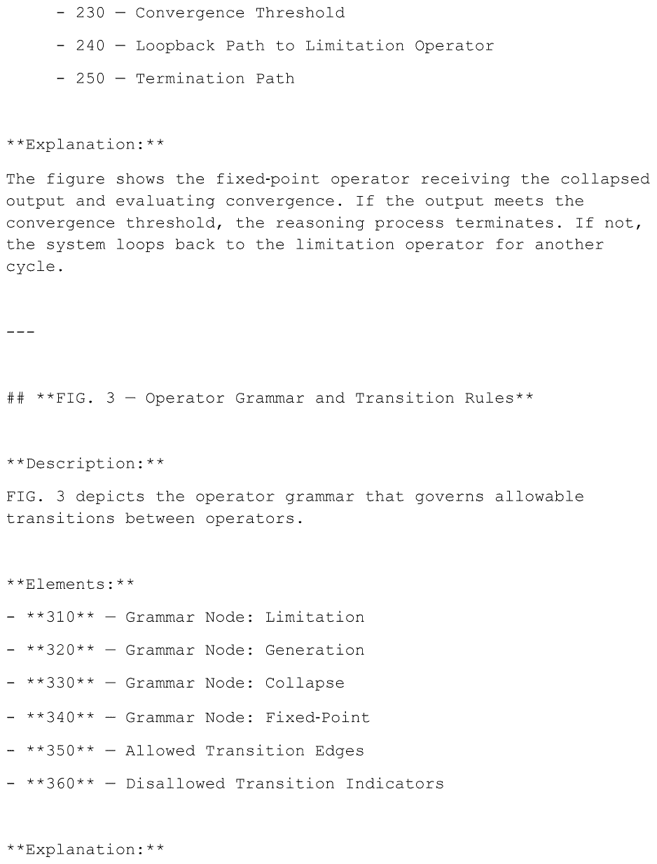

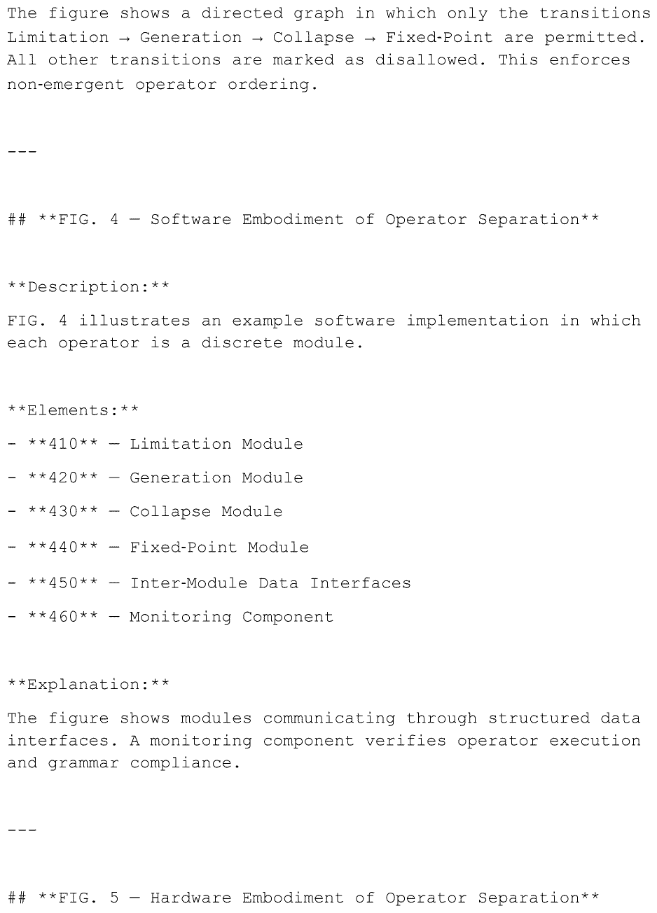

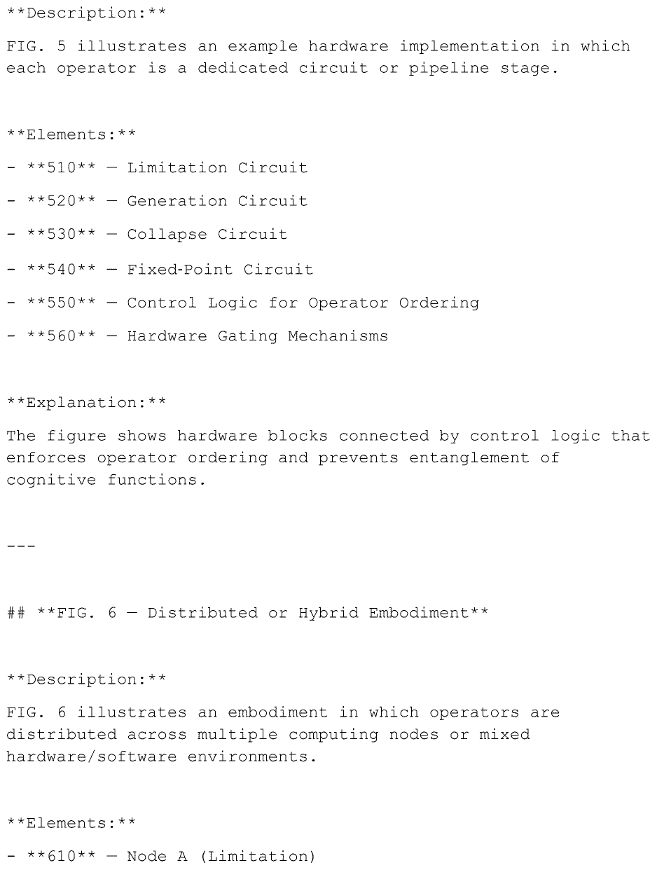

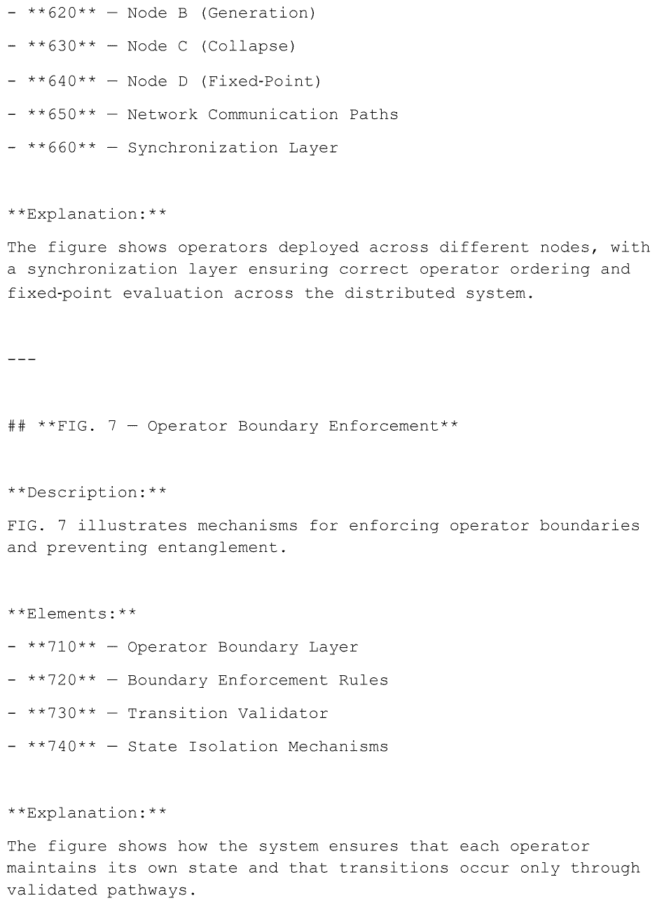

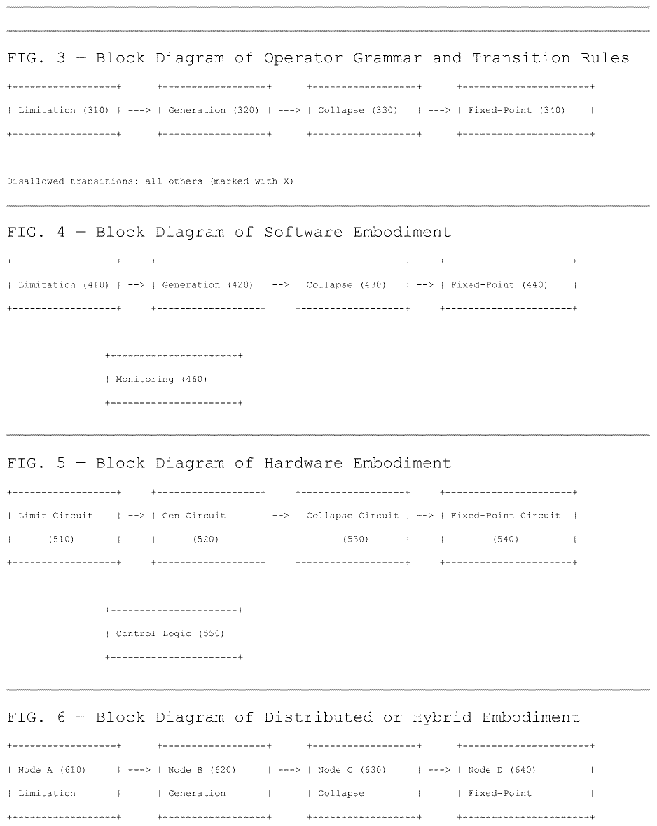

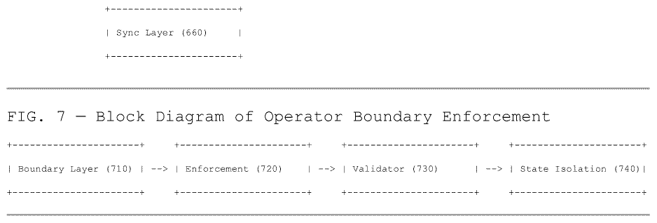

### TECHNICAL FIELD

This invention relates to cognitive architectures for artificial intelligence systems. More specifically, it concerns architectures in which cognitive functions are implemented through structurally separated operators that execute in a defined order to improve stability, coherence, and reasoning performance.

### BACKGROUND OF THE INVENTION

Current AI systems, including large language models, agentic systems, and hybrid symbolic-neural architectures, rely on monolithic or loosely modular computational pipelines. In these systems, generation, evaluation, constraint application, and convergence behaviors are typically emergent rather than structurally defined. As a result, reasoning quality is inconsistent, drift accumulates across inference steps, and system behavior becomes difficult to predict or control.

Existing architectures generally treat cognitive functions as *learned behaviors* rather than *explicit operators*. Generation and evaluation are often entangled within the same model weights, or implemented as ad-hoc secondary models without formal boundaries. Constraint mechanisms, when present, are typically post-hoc filters or safety layers rather than first-class components of the reasoning process. Collapse or convergence behavior is not treated as a designed operator but as a byproduct of sampling or optimization.

These limitations create instability in multi-step reasoning, reduce reproducibility, and make it difficult to guarantee coherent outputs across long inference sequences. As AI systems are increasingly deployed in high-stakes environments, the absence of structural reasoning guarantees becomes a critical bottleneck.

### SUMMARY OF PRIOR ART

A review of existing patents and published systems reveals several categories of related work, none of which address the structural issues solved by the present invention:

### 1. Generator-Critic and Multi-Model Architectures

Systems such as GANS, RLHF pipelines, and debate-style evaluators separate models functionally but do not define or enforce operator boundaries. These systems lack a formal operator grammar and do not specify ordering, transitions, or structural constraints.

### 2. Modular or Pipeline-Based AI Systems

Some architectures divide processing into modules (e.g., parsing, planning, generation), but these modules are not operators in the formal sense. They do not enforce limitation-before-generation, do not implement collapse as a controlled operator, and do not include fixed-point anchoring.

### 3. Safety Filters and Post-Processing Layers

Content filters, toxicity classifiers, and rule-based safety systems operate after generation. They do not constrain the reasoning process itself and do not provide structural coherence or stability.

### 4. Optimization and Convergence Techniques

Methods such as iterative refinement, beam search, or optimization-based inference provide convergence behavior but do not define a fixed-point operator as part of a cognitive architecture.

Across all surveyed systems, no prior art discloses a cognitive architecture in which reasoning is performed through **explicit, structurally separated operators**—including limitation, generation, collapse, and fixed-point operators—executed in a defined order with enforced boundaries.

### NEED FOR THE INVENTION

There is a need for an architecture that:
defines cognitive functions as explicit operators
enforces operator boundaries and transitions
ensures limitation precedes plenitude
treats collapse as a first-class operator
anchors reasoning to a fixed-point state
produces non-emergent coherence
reduces drift across inference steps

The present invention addresses these deficiencies by introducing an operator-separated cognitive architecture designed to stabilize AI reasoning at the structural level.

### DETAILED DESCRIPTION

### Overview of the Architecture

The invention provides a cognitive architecture in which reasoning is performed through a sequence of ** explicit, structurally separated operators**. Each operator performs a distinct cognitive function, and transitions between operators follow a defined operator grammar. The architecture replaces emergent reasoning behaviors with a non-emergent, operator-driven pipeline that produces stable, coherent, and drift-resistant outputs.

The architecture may be implemented in software, hardware, firmware, distributed systems, or hybrid environments. In all embodiments, the defining characteristic is the presence of **operator separation** and **operator ordering**, not the substrate on which the operators execute.

### Operator Set

### 1. Limitation Operator

The limitation operator establishes constraints, boundaries, or scoping conditions prior to any generative activity. These limitations may include:
semantic boundaries
structural constraints
domain restrictions
safety or compliance rules
logical or mathematical constraints
resource or time limitations

The limitation operator produces a bounded reasoning space that the generation operator must respect. In various embodiments, the limitation operator may:
prune the search space
define allowable transformations
restrict the form or type of outputs
enforce domain-specific rules
apply user-defined or system-defined constraints

The limitation operator ensures that plenitude does not occur without structure.

### 2. Generation Operator

The generation operator produces candidate outputs within the boundaries established by the limitation operator. Unlike monolithic AI systems, generation is not entangled with evaluation or collapse. The generation operator may:
produce multiple candidate outputs
generate structured or unstructured representations
create symbolic, neural, hybrid, or multimodal outputs
operate deterministically or stochastically

In all embodiments, the generation operator is **constrained** by the output of the limitation operator. It cannot exceed or violate the established boundaries.

### 3. Collapse Operator

The collapse operator performs controlled reduction, selection, consolidation, or transformation of generated possibilities. This operator is distinct from emergent sampling or heuristic filtering. The collapse operator may:
select a single output
reduce a set of candidates
merge or reconcile conflicting outputs
apply ranking or scoring mechanisms
enforce structural coherence
The collapse operator ensures that the reasoning process transitions from plenitude to a manageable, interpretable state.

### 4. Fixed-Point Operator

The fixed-point operator anchors the reasoning process to a stable convergence state. This operator ensures that multi-step reasoning does not drift, diverge, or oscillate. The fixed-point operator may:
enforce convergence criteria
compare current outputs to prior states
detect instability or deviation
apply correction mechanisms
terminate or continue reasoning based on stability thresholds

In various embodiments, the fixed-point operator may compute:
semantic fixed points
structural fixed points
logical fixed points
numerical or optimization-based fixed points

The fixed-point operator provides architectural stability across inference steps.

### Operator Grammar and Ordering

The architecture defines a **formal operator grammar** that governs transitions between operators. At minimum, the grammar enforces:
1. Limitation precedes generation
2. Generation precedes collapse
3. Collapse precedes fixed-point evaluation
4. Fixed-point evaluation determines whether the sequence repeats or terminates**

Additional operators may be inserted, but the core ordering remains invariant.

The grammar prevents entanglement of cognitive functions and ensures that reasoning proceeds through a predictable, non-emergent sequence.

### EMBODIMENTS

### Software Embodiment

In a software implementation, each operator may be implemented as:
a function
a module
a microservice
a neural component
a symbolic component
a hybrid component

Operators may communicate through shared memory, message passing, or structured data formats.

### Hardware Embodiment

In a hardware implementation, each operator may be implemented as:
a dedicated circuit
a hardware pipeline stage
a microcoded instruction set
a reconfigurable logic block

Operator boundaries are enforced through hardware gating, sequencing logic, or control signals.

### Hybrid Embodiment

In hybrid systems, operators may be distributed across:
software layers
hardware accelerators
embedded controllers
distributed nodes

The operator grammar remains consistent across substrates.

### Monitoring and Compliance Mechanisms

In various embodiments, the architecture includes mechanisms for:
verifying operator execution
detecting deviations from the operator grammar
logging operator transitions
enforcing boundary compliance
monitoring fixed-point stability

These mechanisms ensure that the system adheres to the operator-separated design.

### Advantages of the Invention

The operator-separated cognitive architecture provides:
non-emergent coherence
reduced drift across inference steps
predictable reasoning behavior
structural stability
improved reproducibility
modular extensibility
substrate independence

These advantages arise from the explicit separation and ordering of cognitive operators, which is not disclosed in any prior art.

### IMPLEMENTATION EXAMPLE

### Example 1: Core Operator-Separated Reasoning Loop

```
‘‘‘pseudo
procedure OPERATOR_SEPARATED_REASONING (initial_input) :
  # Initialize reasoning state
  state := initial_input
  loop:
    # Step 1: Apply limitation operator
    limited_state := LIMITATION_OPERATOR (state)
    # Step 2: Generate candidate outputs within
boundaries
    candidates := GENERATION_OPERATOR (limited_state)
    # Step 3: Collapse candidates into a reduced or
selected output
    collapsed_output := COLLAPSE_OPERATOR (candidates)
    # Step 4: Evaluate fixed-point stability
    convergence_result :=
FIXED_POINT_OPERATOR (collapsed_output)
    # Step 5: Check convergence condition
    if convergence_result.is_converged = TRUE then
      return convergence_result.output
    else
      # Update state and repeat the operator sequence
      state := convergence_result.output
      goto loop
‘‘‘
- - -
```

### Example 2: Structural Definitions of Operators (Non-Proprietary Stubs)

```
‘‘‘pseudo
function LIMITATION_OPERATOR (input_state) :
  # Establish constraints, boundaries, or scoping rules
  # Examples: domain limits, safety rules, structural
constraints
  constrained_state := APPLY_CONSTRAINTS (input_state)
  return constrained_state
‘‘‘
‘‘‘pseudo
function GENERATION_OPERATOR (constrained_state) :
  # Produce one or more candidate outputs within the
established boundaries
  # The internal generation mechanism may be neural,
symbolic, hybrid, or other
  candidates := PRODUCE_CANDIDATES (constrained_state)
  return candidates
‘‘‘
‘‘‘pseudo
function COLLAPSE_OPERATOR (candidates) :
  # Perform controlled reduction, selection, or
consolidation
  # Examples: ranking, scoring, merging, or filtering
  collapsed_output : = REDUCE_CANDIDATES (candidates)
  return collapsed_output
‘‘‘
‘‘‘pseudo
function FIXED_POINT_OPERATOR (collapsed_output) :
  # Evaluate stability and determine whether a fixed
point has been reached
  # Examples: semantic stability, structural consistency,
logical convergence
  is_converged := CHECK_CONVERGENCE (collapsed_output)
  result := NEW_CONVERGENCE_RESULT ( )
  result.output : = collapsed_output
  result.is_converged := is_converged
  return result
‘‘‘
- - -
```

### Example 3: Non-Recursive Variant (Iterative Embodiment)

```
‘‘‘pseudo
procedure
OPERATOR_SEPARATED_REASONING_ITERATIVE (initial_input,
max_iterations) :
  state := initial_input
  for i from 1 to max_iterations do
    limited_state := LIMITATION_OPERATOR (state)
    candidates := GENERATION_OPERATOR (limited_state)
    collapsed_output := COLLAPSE_OPERATOR (candidates)
    convergence_result :=
FIXED_POINT_OPERATOR (collapsed_output)
  if convergence_result.is_converged = TRUE then
    return convergence_result.output
    state := convergence_result.output
  end for
  # If no convergence within max_iterations, return last
state
  return state
‘‘‘
```

### SUMMARY OF THE INVENTION

The invention provides a cognitive architecture in which reasoning is performed through a set of explicit, structurally separated operators that execute in a defined order to produce stable, coherent, and drift-resistant outputs. Unlike current AI systems, where reasoning behaviors emerge implicitly from model weights or loosely coupled modules, the present architecture defines cognitive functions as first-class operators with formal boundaries, transitions, and constraints.

At minimum, the architecture includes four operators:
a limitation operator that establishes constraints, boundaries, or scoping conditions prior to any generative activity,
   a generation operator that produces candidate outputs within the established limitations,
   a collapse operator that performs controlled reduction, selection, or consolidation of generated possibilities, and
   a fixed-point operator that anchors the reasoning process to a stable convergence state, ensuring consistency across inference steps.

These operators are arranged in a non-emergent reasoning pipeline in which each operator performs a distinct cognitive function and hands off to the next according to a defined operator grammar. The architecture enforces that limitation precedes plenitude, that generation occurs only within predefined boundaries, that collapse is a designed operator rather than an emergent sampling behavior, and that convergence is achieved through an explicit fixed-point mechanism.

The operator-separated design enables predictable reasoning behavior, reduces drift across multi-step inference, and provides structural guarantees that are not achievable in monolithic or entangled systems. Because the operators are discrete and composable, the architecture can be implemented in software, hardware, hybrid systems, or distributed environments. It can also be extended with additional operators or operator variants without altering the core structure.

In various embodiments, the invention includes methods for executing operator transitions, enforcing operator boundaries, maintaining fixed-point stability, and integrating the operator pipeline into existing AI systems. The architecture may also incorporate monitoring, verification, or introspection mechanisms that ensure operator compliance and detect deviations from the defined reasoning sequence.

Overall, the invention introduces a structural solution to instability and inconsistency in AI reasoning by replacing emergent cognitive behaviors with an explicit operator-based architecture.

1. A system for performing AI reasoning, comprising:
a limitation operator configured to establish one or more constraints defining a bounded reasoning space;
a generation operator configured to produce one or more candidate outputs within the bounded reasoning space established by the limitation operator;
a collapse operator configured to perform a controlled reduction, selection, or consolidation of the one or more candidate outputs produced by the generation operator; and
a fixed-point operator configured to evaluate a state of convergence of the reduced, selected, or
consolidated output and to determine whether additional operator cycles are required;
wherein the limitation operator, generation operator, collapse operator, and fixed-point operator are **structurally separated** and executed according to a defined operator ordering that enforces limitation prior to generation, generation prior to collapse, and collapse prior to fixed-point evaluation.

2. The system of claim 1, wherein the limitation operator applies semantic, structural, logical, or domain-specific constraints to restrict the form or scope of candidate outputs.

3. The system of claim 1, wherein the generation operator produces multiple candidate outputs using neural, symbolic, hybrid, or multimodal generation techniques.

4. The system of claim 1, wherein the collapse operator selects a single output from a plurality of candidate outputs based on ranking, scoring, coherence evaluation, or rule-based criteria.

5. The system of claim 1, wherein the fixed-point operator computes a semantic, structural, logical, or numerical fixed point to determine convergence.

6. The system of claim 1, wherein the operator ordering is enforced by an operator grammar defining allowable transitions between operators.

7. The system of claim 1, wherein the operators are implemented as discrete software modules communicating through structured data interfaces.

8. The system of claim 1, wherein the operators are implemented as hardware circuits, pipeline stages, or microcoded instruction sequences.

9. The system of claim 1, wherein the operators are distributed across multiple computing nodes in a networked or cloud-based environment.

10. The system of claim 1, further comprising a monitoring component configured to verify operator execution, detect deviations from the operator grammar, or enforce boundary compliance.

11. A method for performing AI reasoning, comprising:
(a) establishing one or more constraints defining a bounded reasoning space using a limitation operator;
(b) generating one or more candidate outputs within the bounded reasoning space using a generation operator;
(c) performing a controlled reduction, selection, or consolidation of the candidate outputs using a collapse operator; and
(d) evaluating a state of convergence using a fixed-point operator to determine whether additional operator cycles are required;
wherein steps (a) through (d) are performed in a defined operator order and by structurally separated operators.

12. The method of claim 11, further comprising repeating steps (a) through (d) until the fixed-point operator determines that a convergence threshold has been met.

13. The method of claim 11, wherein the limitation operator restricts the reasoning space based on safety rules, domain rules, or user-defined constraints.

14. The method of claim 11, wherein the collapse operator merges, reconciles, or ranks candidate outputs prior to fixed-point evaluation.

15. A non-transitory computer-readable medium storing instructions that, when executed by one or more processors, cause the processors to perform the method of any of claims 11-14.

16. An apparatus comprising hardware logic configured to implement the limitation operator, generation operator, collapse operator, and fixed-point operator of claim 1, wherein the hardware logic enforces operator separation and operator ordering.

17. The system of claim 1, wherein the operator-separated cognitive architecture is integrated into an existing AI model, agent, or reasoning engine to provide structural stability and drift reduction.

18. The system of claim 1, wherein, when the fixed-point operator determines that convergence has not been reached, an output of the fixed-point operator is provided as an updated reasoning state to a subsequent execution of the limitation operator in a further operator cycle.

19. The system of claim 1, wherein the limitation operator, generation operator, collapse operator, and fixed-point operator are each implemented as stateless components that receive all required context via structured inputs and do not retain internal state across operator cycles.

20. The system of claim 1, wherein the fixed-point operator is configured to produce both (i) a convergence indicator and (ii) a transformed output, and the convergence indicator determines whether the transformed output is returned as a final result or supplied as input to a subsequent operator cycle.
